(19) United States
(12) Patent Application Publication
(10) Pub. No.: US 2013/0270047 A1
(43) Pub. Date: Oct. 17, 2013

(54) ELECTRIC PARKING BRAKE

(71) Applicant: Jin Seok Kim, Suwon-si (KR)

(72) Inventor: Jin Seok Kim, Suwon-si (KR)

(21) Appl. No.: 13/864,105

(22) Filed: Apr. 16, 2013

(30) Foreign Application Priority Data
Apr. 17, 2012 (KR) 10-2012-0039818

(51) Int. Cl. F16D 65/18

(52) U.S. Cl. CPC F16D 65/18
USPC 188/72.1

(57) ABSTRACT

Disclosed is an electric parking brake (EPB). The EPB includes a carrier at which a pair of pad plates is installed, a caliper housing slidably installed at the carrier and provided with a cylinder in which a piston is installed, a spindle member arranged through a rear wall of the caliper housing and adapted to rotate, a pressing device provided with a nut member screw-coupled with the spindle member to apply pressure and release pressure applied to the piston according to rotation of the spindle member, and an actuator unit to transmit rotational force to the pressing unit. The actuator unit includes a plurality of motors installed at an outer surface of the caliper housing, and a reducer to amplify the driving force and transmit the driving force to the spindle member. Each of the motors is adapted to be independently controlled by an electronic control unit.

### CROSS-REFERENCE TO RELATED APPLICATION(S)

This application claims the benefit of Korean Patent Application No. 2012-0039818, filed on Apr. 17, 2012 in the Korean Intellectual Property Office, the disclosure of which is incorporated herein by reference.

### BACKGROUND

1. Field

Embodiments of the present invention relate to an electric parking brake which may implement the function of parking through operation of an electric motor.

2. Description of the Related Art

A parking brake generally serves to apply braking force to wheels of a vehicle to prevent the wheels from rotating such that the vehicle remains stopped when parked.

An electronic parking brake (EPB) system, which has recently been used to electronically control the operation of a parking brake, is mounted to a general disc brake to function as a parking brake. Such EPBs are classified into a cable puller type, a motor-on-caliper type and a hydraulic parking brake type.

FIG. 1 is a view schematically illustrating a conventional EPB. The EPB shown in FIG. 1 is of the motor-on-caliper type.

With reference to FIG. 1, the EPB, which is of a disc brake type, is provided with a carrier 1 supporting first and second friction pads (not shown) disposed on both sides of the disc (not shown) and allowing the same to be movable forward and backward, a caliper housing 2 to press the friction pads, and a piston (not shown), so as to perform braking. In addition, a pressing device (not shown) to apply pressure to the piston is provided within the cylinder of the caliper housing 2. The pressing device is a commonly known technology that converts rotational force transmitted thereto into rectilinear motion, and thus a detailed description thereof will be omitted.

In order to transmit rotational force to the pressing device, the EPB includes a motor 3 to generate driving force, a reducer 8 to amplify the driving force generated by the motor 3, and a gear assembly 7 to transmit the driving force from the motor 3 to the reducer 8.

The gear assembly 7 includes a drive gear 4 installed at a rotating shaft of the motor 3, a driven gear 6 connected with the reducer 8 and a connecting gear 5 connecting the drive gear 4 and the driven gear 6. And a planetary gear unit functions as the reducer 8. Reference numeral ‘9’ indicates a case accommodating the motor 3, gear assembly 7 and reducer 8 and installed at the caliper housing 2.

However, the EPB as above uses one motor 3 and thus may require high voltage. Further, as it is adapted to transmit the driving force to the reducer 8 through the gear assembly 7, it may have a complicated structure and be disadvantageous in relation to operational noise during braking.

Further, there may be limit to mounting the EPB to a vehicle since the motor 3 is disposed on one side of the caliper housing 2.

In addition, if the motor 3 breaks down, braking may not be performed.

Thus, various research and development has been conducted to improve usability of an installation space for an EPB which automatically operates the brake using the motor 3 and to reduce operational noise.

### SUMMARY

Accordingly, it is an aspect of the present invention to provide an electronic parking brake (EPB) which may provide sufficient braking force using low voltage motors, and increase usability of an installation space for the EPB and reduce operational noise with a simplified structure for transmission of rotational force.

It is another aspect of the present invention to provide a plurality of small motors to ensure braking operation when any one of the motors breaks down.

Additional aspects of the invention will be set forth in part in the description which follows and, in part, will be obvious from the description, or may be learned by practice of the invention.

In accordance with one aspect of the present invention, an EPB having a carrier at which a pair of pad plates is installed to be movable forward and backward, a caliper housing slidably installed at the carrier and provided with a cylinder in which a piston is installed to be movable forward and backward, a spindle member arranged through a rear wall of the caliper housing and adapted to rotate in the cylinder, a pressing device provided with a nut member screw-coupled with the spindle member to apply pressure and release pressure applied to the piston by moving forward and backward according to rotation of the spindle member, and an actuator unit to transmit rotational force to the pressing unit, wherein the actuator unit may include a plurality of motors installed at an outer surface of the caliper housing to generate driving force to rotate the spindle member, and a reducer to amplify the driving force generated from the motors and transmit the driving force to the spindle member, wherein each of the motors is adapted to be independently controlled by an electronic control unit.

The reducer may include a reduction gear portion connected to drive gears installed at respective rotating shafts of the motors to receive rotational force from the motors, a first planetary gear unit including a first sun gear connected to a center of the reduction gear portion, a plurality of first planetary gears engaged with the first sun gear at an outer side of the first sun gear, a first ring gear provided with an inscribed gear to accommodate the first planetary gears, and a first carrier connected to respective central shafts of the first planetary gears to output rotational power; and a second planetary gear unit including a second sun gear installed at a central shaft of the first carrier, a plurality of second planetary gears engaged with the second sun gear at an outer side of the second gear; a second ring gear provided with an inscribed gear to accommodate the second planetary gears, and a second carrier installed at the spindle member to be connected with respective central shafts of the second planetary gears to transmit rotational power to the spindle member.

The reduction gear portion may be integrated with the first sun gear.

The reduction gear portion may include a spur gear or a helical gear, and the motors may be disposed in parallel to allow engagement of the drive gears with the reduction gear portion to occur on the same line.

The drive gears of the motors and the reduction gear portion may be disposed in parallel to lie on the same line, and the reduction gear portion is connected with the drive gears by a belt to receive rotational force

In accordance with another aspect of the present invention, each of the motors may be installed to be arranged at a predetermined angle to allow the reduction gear portion to be engaged with the drive gears of the motors in a bevel gear assembly structure.

Each of the motors may be adapted to be independently controlled by an electronic control unit.

The motors may be small motors which are operable at a low voltage.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a view schematically illustrating a conventional electric parking brake (EPB);

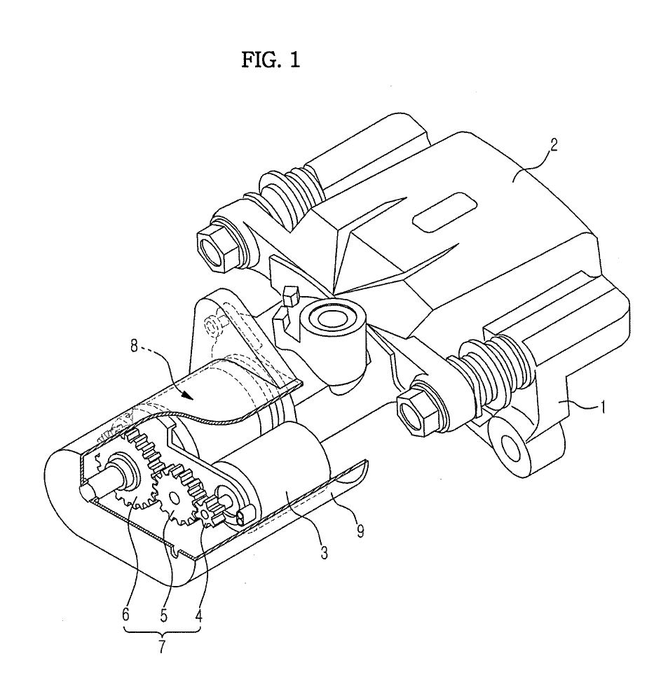

FIG. 2 is a lateral cross-sectional view illustrating an EPB according to an exemplary embodiment of the present invention;

FIG. 3 is a cross-sectional plan view illustrating the EPB in FIG. 2;

FIG. 4 is a view illustrating an actuator unit of an EPB according to another embodiment of the present invention; and

FIG. 5 is a view illustrating an actuator unit of an EPB according to another embodiment of the present invention.

### DETAILED DESCRIPTION

Reference will now be made in detail to the embodiments of the present invention, examples of which are illustrated in the accompanying drawings. It should be understood that the terms used in the specification and appended claims should not be construed as limited to general and dictionary meanings but should be construed based on the meanings and concepts according to the spirit of the present invention on the basis of the principle that the inventor is permitted to define appropriate terms for best explanation. The preferred embodiments described in the specification and shown in the drawings are only illustrative and are not intended to represent all aspects of the invention, such that various equivalents and modifications may be made without departing from the spirit of the invention.

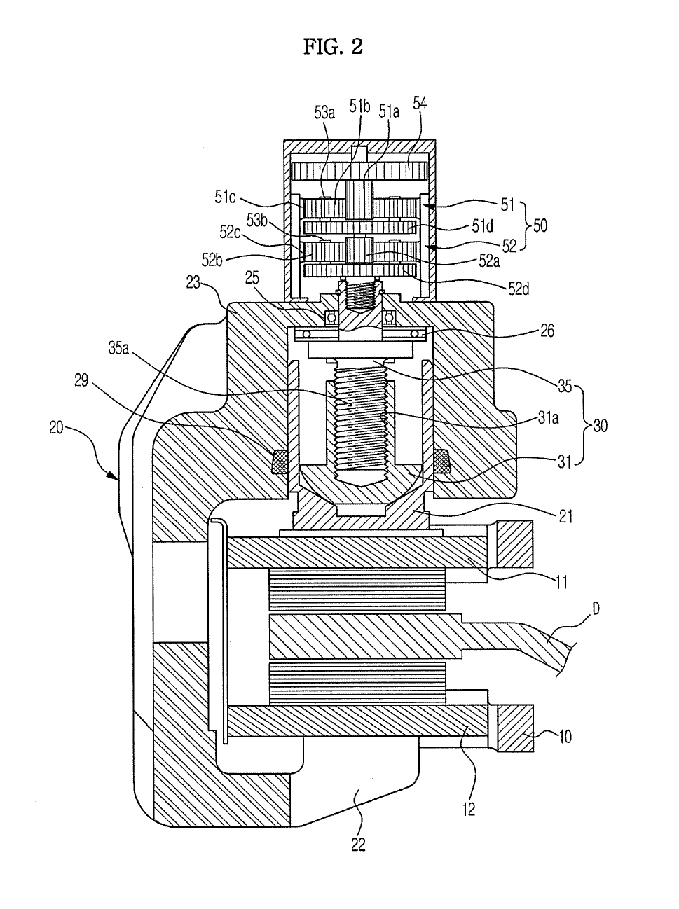

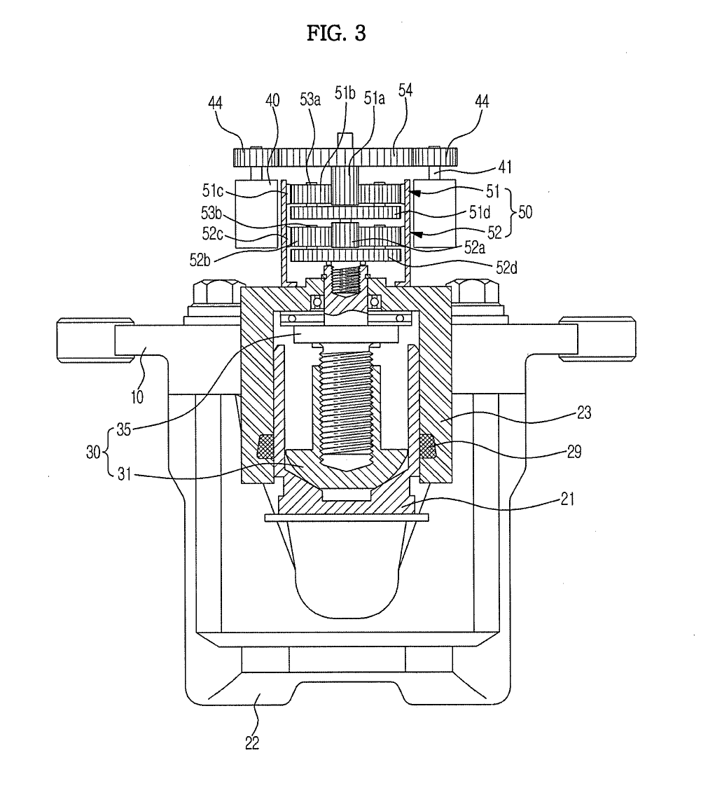

FIG. 2 is a lateral cross-sectional view illustrating an electric parking brake (EPB) according to an exemplary embodiment of the present invention, and FIG. 3 is a cross-sectional plan view illustrating the EPB of FIG. 2.

With reference to FIGS. 2 and 3, the EPB includes a disc D rotating together with a wheel (not shown) of a vehicle, a carrier 10 at which a pair of pad plates 11 and 12 is disposed to be pressed against opposite sides of the disc D to perform braking, a caliper housing 20 in which a piston 21 is installed to be movable forward and backward to apply pressure to the pad plates 11 and 12, an actuator unit including a plurality of motors 40 to generate driving force and a reducer 50 connected with the motors 40, and a pressing device 30 to convert rotational force of the actuator unit into rectilinear reciprocating motion to apply pressure to the piston 21.

The pad plates 11 and 12 are divided into the inner pad plate 11 disposed to adjoin the piston 21, and the outer pad plate 12 disposed to adjoin a finger 22, which will be described below. The pad plates 11 and 12 are installed at the carrier 10, which is fixed to a vehicle body, to be movable to advance to and withdraw from the opposite sides of the disc D, and the caliper housing 20 is also installed at the carrier 10 to slide in the direction of pressure applied to the pad plates 11 and 12.

The caliper housing 20 is provided, on the rear side thereof, with a cylinder 23 having the piston 21 installed therein, and provided, on the front side thereof, with the finger 22 which is bent downward to operate the outer pad plate 12 and integrated with the cylinder 23.

The piston 21 is cylindrically formed to have a cup-shaped inner space and is inserted into the cylinder 23 to be slidable within the cylinder 23. The piston 21 is forced to press the inner pad plate 11 against the disc D by axial force of the pressing device 30, to which the rotational force of the motors 40 is transmitted.

The caliper housing 20 is provided with an oil port (not shown) into which brake oil flows to apply hydraulic brake pressure to the inside of the cylinder 23, and a sealing member 29 is arranged between the outer surface and inner surface of the cylinder 23 to prevent oil leakage.

Thus, when the hydraulic brake pressure is applied to the inside of the cylinder 23 to perform braking, the piston 21 moves toward the inner pad plate 11 applies apply pressure to the inner pad plate 11, and the caliper housing 20 moves in the opposite direction to that of movement of the piston 21 to allow the finger 22 to apply pressure to the outer pad plate 12, thereby braking the disc D.

The EPB of the illustrated embodiment implements the function of parking that may apply baking force to the disc D, so as to park the vehicle.

The pressing device 30, which serves to press the piston 21 toward the inner pad plate 11 as described above, is arranged within the cylinder 23. The pressing device 30 includes a nut member 31 provided, inside thereof, with a female thread portion 31a, and a spindle member 35 having a male thread portion 35a to be screw-coupled with the female thread portion 31 a of the nut member 31.

The spindle member 35 is installed through the cylinder 23 and is rotatalby arranged in the cylinder 23 with the spindle member 35 placed in parallel with the direction of forward and backward movement of the nut member 31. To support the spindle member 35, a first bearing 25 and a second bearing 26 are installed at positions in the cylinder 23 spaced apart from each other. Here, the second bearing 26, which is a thrust bearing, receives reaction force generated in the direction of forward and backward movement of the nut member 31 and transmitted through the spindle member 35. The nut member 31 is arranged to contact the piston 21.

The actuator unit includes a plurality of motors 40 and a reducer 50 connected to the respective motors 40, as described above.

The motors 40 are disposed toward the rear side of the caliper housing 20. For the plural motors 40, small motors that are actuated at a low voltage are provided. Thereby, the volume of the motors 40 decreases, and thus the motors 40 are allowed to be disposed in an empty space behind the caliper housing 20, with an improved mountability. In addition, by using a plurality of small motors 40, noise that occurs in performing braking may be reduced, and obtaining power from the distributed motors 40 may be advantageous in relation to noise and strength of the gears.

According to the illustrated embodiment, a pair of motors is provided for the motors 40 to transmit rotational force to a reduction gear portion 54 of the reducer 50, which will be described below. There is no limit to the number of the motors 40. Three or more of the motors 40 may be installed to be used so long as interference with the other components is avoided. A drive gear 44 is installed at the rotating shaft 41 of each of the motors 40 to transfer driving force.

The operation of the motors 40 is controlled by an electronic control unit (ECU) (not shown) connected to the motors 40. For example, the ECU controls various operations of the motors 40 such as start and stop, normal rotation and reverse rotation through an input signal transmitted according to a command from a driver. When a command is given by the driver to operate or release the brake, the ECU rotates the motors 40 in the normal or reverse direction. In addition, the ECU may be provided with a counter sensor which counts the number of rotations of the motors 40 or a current sensor which senses the amount of current, so that the motors 40 may be controlled according to number of rotations or amount of current sensed by the counter sensor or the current sensor. That is, the plural motors 40 may be controlled to operate together or independently, by the ECU. The control of the motors 40 using the ECU is a commonly known technology, and thus a detailed description thereof will be omitted.

The reducer 50 according to the illustrated embodiment is provided in the form of two-stage planetary gears. That is, the reducer 50 includes a reduction gear portion 54 to receive driving force from the motors 40, a first planetary gear unit 51 and a second planetary gear unit 52.

The reduction gear portion 54 is engaged with respective drive gears 44 of the motors 40 along the circumference of the reduction gear portion 54. The reduction gear portion 54 is formed by a single gear, for which a spur gear or a helical gear may be employed.

The first planetary gear unit 51 includes a first sun gear 51a connected to a center of the reduction gear, a plurality of first planetary gears 51b engaged with the first sun gear 51a at an outer side of the first sun gear 51a, a first ring gear 51c provided with an inscribed gear to accommodate the first planetary gears 51b, and a first carrier 51d connected to respective central shafts 53a of the first planetary gears 51b to output rotational power. The central shaft of the reduction gear portion 54 may be arranged to be connected to the first sun gear 51a, or the reduction gear portion 54 may be integrated with the first sun gear 51a.

The second planetary gear unit 52 has the same structure as the first planetary gear unit 51. That is, the second planetary gear unit 52 includes a second sun gear 52a installed at a central shaft of the first carrier 51d, a plurality of second planetary gears 52b engaged with the second sun gear 52a at the outer side of the second sun gear 52a, a second ring gear 52c provided with an inscribed gear to accommodate the second planetary gears 52b, and a second carrier 52d connected to respective central shafts 53b of the second planetary gears 52b to output rotational power. The central shaft of the second carrier 52d is coupled with the spindle member 35. Thereby, the driving force is amplified by the planetary gear units 51 and 52 formed in multiple stages and transmitted to the spindle member 35.

That is, when the rotational force is transmitted to the planetary gear units 51 and 52 through the reduction gear portion 54 by the operation of the plurality of the motors 40, the first planetary gears 51b engaged with the fixed first ring gear 15c revolve around the first sun gear 51a as the first sun gear 51a rotates. And as the first planetary gears 51b revolve, the rotational power is transmitted to the second planetary gear unit 52 through the first carrier 51d. The second planetary gear unit 52 transmits the rotational force to the spindle member 35 through the same operation as that of the first planetary gear unit 51 to produce reduced rotation of the spindle member 35. When the spindle member 35 rotates, the nut member 31 moves in an axial direction, and braking is performed as the nut member 31 applies pressure to the piston 21.

The reducer 50 is adapted to rotate the spindle member 35 with a large force from the miniaturized motors 40, which are the driving source, and to maintain the parking state by restricting the rotation of the spindle member 35 with a high reduction ratio of the reducer 50 when the motors 40 are stopped with braking performed to park the vehicle.

In the illustrated embodiment, the reducer 50 is shown and described as employing a two-stage planetary gear assembly, but embodiments of the present invention are not limited thereto. So long as the driving force is amplified and transmitted to the pressing device 30, any of various known structures of the reducer may be employed. For example, a cycloid reducer may be used, which includes an inner gear to receive rotational force through a reduction gear portion and eccentrically rotate and an outer gear disposed to be engaged with the outer circumferential surface of the inner gear such that the eccentrically rotating inner gear performs both rotation and revolution, and a spindle connected with the inner gear to compensate the eccentricity of the inner gear and transmit the reduction ratio according to the difference between the number of teeth of the inner gear and that of the outer gear.

Hereinafter, braking operation of the EPB as above to park the vehicle will be described.

When a control switch (not shown) arranged near the driver's seat in a vehicle is operated by the driver to park the vehicle, the motors 40 rotate. The motors 40 generate rotational force, rotating in the same direction. The rotation of the motors 40 is reduced through the reducer 50 to rotate the spindle member 35 with a large force. As the spindle member 35 rotates, the nut member 31 is moved in an axial direction and applies pressure to the piston 21 to perform braking.

After braking is performed, the motors 40 are stopped. Since the reducer 50 has a large reduction ratio, the spindle member 35 is prevented from rotating. Accordingly, braking is maintained until the motors 40 are actuated again.

When braking is released, the control switch at the driver's seat is operated. In this operation, the motors 40 rotate in the direction opposite to that of rotation in braking, and the spindle member 35 also rotates in the direction opposite to that of rotation in braking, and thereby the nut member 31 releases pressure applied to the piston 21 to release braking.

When breakdown of some of the motors 40 occurs, rotational force is transmitted using the remaining motors 40, and thus braking and release of braking may be performed.

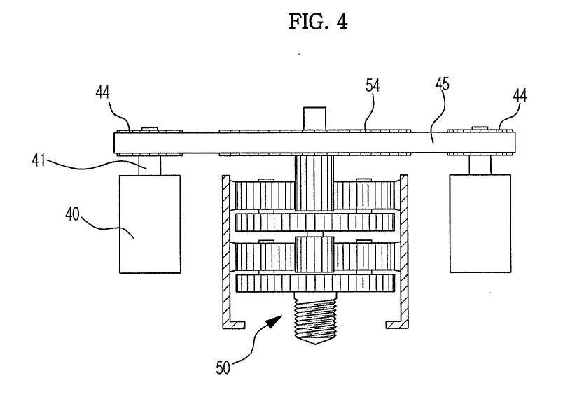

In addition, the motors 40 are shown and described as being disposed in parallel to allow engagement of the drive gears 44 with the reduction gear portion 54 to occur on the same line, but embodiments of the present invention are not limited thereto. The driving force may be transmitted using a separate power transmission member. For example, an actuator unit of an EPB in accordance with another embodiment of the present invention is shown in FIG. 4.

With reference to FIG. 4, the actuator unit of the another embodiment is arranged such that the drive gears 44 of the motors 40 are disposed in parallel with the reduction gear portion 54, spaced a distance apart from the reduction gear portion 54. Accordingly, the reduction gear portion 54 and drive gears 44 are connected to each other by a power transmission member, e.g., a belt 45, in order to transmit driving force from the motors 40 to the reduction gear portion 54. The belt 45 connects the reduction gear portion 54 and the drive gears 44 by surrounding the outer sides of a plurality of drive gears 44 disposed in a radial direction around the reduction gear portion 54. In this embodiment, the elements and operations other than the connection of the belt 45 are substantially identical to those in the previous embodiment, and therefore a description thereof will be omitted.

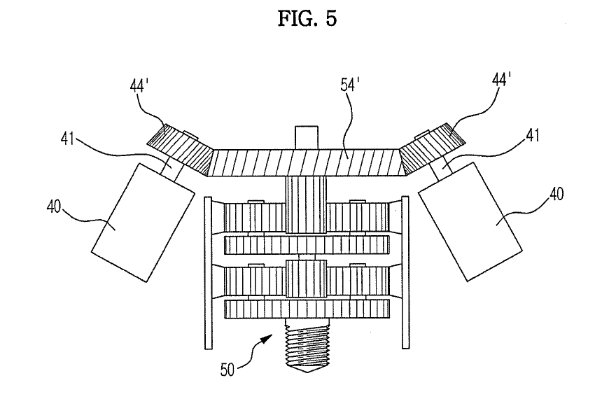

In accordance with another embodiment of the present invention of connecting between the motors 40 and reduction gear portion 54, each of the motors 40 may be arranged to be installed at a predetermined angle in order to facilitate installation of the motors 40 in an empty space at the rear side of the caliper housing 20. For example, an actuator unit of an EPB in accordance with the another embodiment of the present invention is shown in FIG. 5.

With reference to FIG. 5, the actuator unit of the illustrated embodiment has a plurality of motors 40 connected to the reducer 50 with an inclination. That is, the drive gears 44′ installed at the rotating shafts 41 of respective motors 40 are engaged with a reduction gear portion 54′ of the reducer 50 in a bevel gear assembly structure having a conical shape to transmit rotational force. The elements and operations other than the shape and engagement of the drive gears 44′ and reduction gear portion 54′ are substantially identical to those in the previous embodiment, and therefore a description thereof will be omitted.

As is apparent from the above description, an electric parking brake (EPB) according to one embodiment of the present invention is provided with a plurality of motors to produce driving force, and thereby it may generate a sufficiently large braking force even with the low voltage motors.

In addition, when some of the motors break down, braking may be stably performed by the remaining motors.

Further, using small motors may improve space utilization for the EPB, and as the power is obtained from the distributed motors, the EPB may be advantageous in terms of operational noise and strength.

Additionally, the size of a reducer may be reduced by minimizing the number of operations for power transmission and power loss may decrease, compared to conventional cases.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. An electric parking brake (EPB) including a carrier at which a pair of pad plates is installed to be movable forward and backward, a caliper housing slidably installed at the carrier and provided with a cylinder in which a piston is installed to be movable forward and backward, a spindle member arranged through a rear wall of the caliper housing and adapted to rotate in the cylinder, a pressing device provided with a nut member screw-coupled with the spindle member to apply and release pressure to the piston by moving forward and backward according to rotation of the spindle member, and an actuator unit to transmit rotational force to the pressing unit,
wherein the actuator unit comprises:
a plurality of motors installed at an outer surface of the caliper housing to generate driving force to rotate the spindle member; and
a reducer to amplify the driving force generated from the motors and transmit the driving force to the spindle member;
wherein each of the motors is adapted to be independently controlled by an electronic control unit.

2. The EPB according to claim 1, wherein the reducer comprises:
a reduction gear portion connected to drive gears installed at respective rotating shafts of the motors to receive rotational force from the motors;
a first planetary gear unit including a first sun gear connected to a center of the reduction gear portion, a plurality of first planetary gears engaged with the first sun gear at an outer side of the first sun gear, a first ring gear provided with an inscribed gear to accommodate the first planetary gears, and a first carrier connected to respective central shafts of the first planetary gears to output rotational power; and
a second planetary gear unit including a second sun gear installed at a central shaft of the first carrier, a plurality of second planetary gears engaged with the second sun gear at an outer side of the second gear, a second ring gear provided with an inscribed gear to accommodate the second planetary gears, and a second carrier installed at the spindle member to be connected with respective central shafts of the second planetary gears to transmit rotational power to the spindle member.

3. The EPB according to claim 2, wherein the reduction gear portion is integrated with the first sun gear.

4. The EPB according to claim 2, wherein:
the reduction gear portion includes a spur gear or a helical gear; and
the motors are disposed in parallel to allow engagement of the drive gears with the reduction gear portion to occur on the same line.

5. The EPB according to claim 2, wherein the drive gears of the motors and the reduction gear portion are disposed in parallel to lie on the same line, and the reduction gear portion is connected with the drive gears by a belt to receive rotational force.

6. The EPB according to claim 2, wherein each of the motors is installed to be arranged at a predetermined angle to allow the reduction gear portion to be engaged with the drive gears of the motors in a bevel gear assembly structure.

7. The EPB according to claim 1, wherein the motors are small motors which are operable at a low voltage.
